(19) United States
(12) Patent Application Publication
(10) Pub. No.: US 2019/0267582 A1
(43) Pub. Date: Aug. 29, 2019

(54) CAP ASSEMBLY AND SECONDARY BATTERY

(71) Applicant: CONTEMPORARY AMPEREX TECHNOLOGY CO., LIMITED, Ningde City (CN)

(72) Inventors: Bing CHEN, Ningde City (CN); Zhijun Guo, Ningde City (CN); Peng Wang, Ningde City (CN); Zhiyu Wang, Ningde City (CN); Jie Zhang, Ningde City (CN)

(21) Appl. No.: 16/358,366

(22) Filed: Mar. 19, 2019

Related U.S. Application Data
(63) Continuation of application No. PCT/CN2018/078415, filed on Mar. 8, 2018.

(30) Foreign Application Priority Data
Feb. 27, 2018 (CN) 201820274415.1

(51) Int. Cl. H01M 2/04; H01M 2/12; H01M 2/36

(52) U.S. Cl. CPC H01M 2/04; H01M 2/36; H01M 2/12

(57) ABSTRACT

The present disclosure provides a cap assembly and a secondary battery. The cap assembly comprises a cap plate, a reinforcement structure and a vent piece. The cap plate is provided with a through-hole; the vent piece is fixed with the cap plate and covers the through-hole from above. The reinforcement structure is provided in the through-hole and fixed with an inner wall of the through-hole, and the reinforcement structure partially blocks the through-hole. The secondary battery comprises: a case having an opening in a top thereof, an electrode assembly received in the case, and the cap assembly according to the first aspect of the present disclosure fixed with the case in the top. When the secondary battery works normally, a certain amount of gas will be generated inside the secondary battery, thereby leading to a pressure inside the secondary battery increasing. By providing the reinforcement structure in the through-hole, it can increase the strength of the cap plate, thereby reducing deformation of the cap plate when the pressure inside the secondary battery increases, especially deformation of the cap plate at the through-hole, and in turn ensuring the connecting strength between the vent piece and the cap plate, improving the stability and the consistency of vent function of the cap assembly, and promoting the safety performance of the secondary battery.

### REFERENCE TO RELATED APPLICATIONS

This application is a continuation application of PCT/CN2018/078415, filed on Mar. 8, 2018, which claims priority to Chinese Patent Application No. 201820274415.1, filed with the State Intellectual Property Office of the People's Republic of China on Feb. 27, 2018, all of which are incorporated herein by reference in their entirety.

### FIELD OF THE PRESENT DISCLOSURE

The present disclosure relates to the field of battery, and particularly relates to a cap assembly and a secondary battery.

### BACKGROUND OF THE PRESENT DISCLOSURE

A conventional secondary battery generally comprises a case, an electrode assembly received in the case and a cap plate fixed with the case. In order to ensure the safety of the secondary battery, a vent piece is generally provided to the cap plate; when the secondary battery has an accident due to overcharge, short circuit and the like, a large amount of gas will be generated inside the secondary battery, the gas can break the vent piece to achieve the purpose of relieving the pressure.

The cap plate is generally made from plastic or aluminum alloy. When the secondary battery works normally, a certain amount of gas also will be generated in the secondary battery, the generated gas will lead to the cap plate being deformed, especially, the cap plate made from plastic is deformed more seriously. The deformation of the cap plate may make a connecting portion between the vent piece and the cap plate loosen; when the pressure inside the secondary battery reaches a certain value, the vent piece may be disengaged from the connecting portion, and can not be broken in a predetermined position (generally, the vent piece is provided with an indentation, the indentation can make the vent piece broken in a middle region), so it can not ensure the stability and the consistency of the vent structure, affect the safety performance of the secondary battery; in addition, if the connecting portion between the vent piece and the cap plate is loosen, when the pressure inside the secondary battery is within a safe range, the vent piece also may be disengaged from the connecting portion, thereby leading to failure of the secondary battery.

### SUMMARY OF THE PRESENT DISCLOSURE

In view of the problem existing in the background, an object of the present disclosure is to provide a cap assembly and a secondary battery, which can improve the stability and the consistency of vent function of the cap assembly, and promote the safety performance of the secondary battery.

In order to achieve the above object, in a first aspect, the present disclosure provides a cap assembly, which comprises a cap plate, a reinforcement structure and a vent piece. The cap plate is provided with a through-hole; the vent piece is fixed with the cap plate and covers the through-hole from above. The reinforcement structure is provided in the through-hole and fixed with an inner wall of the through-hole, and the reinforcement structure partially blocks the through-hole.

In order to achieve the above object, in a second aspect, the present disclosure provides a secondary battery, which comprises: a case having an opening in a top thereof, an electrode assembly received in the case, and the cap assembly according to the first aspect of the present disclosure fixed with the case in the top.

The present disclosure has the following beneficial effects: when the secondary battery works normally, a certain amount of gas will be generated inside the secondary battery, thereby leading to a pressure inside the secondary battery increasing. By providing the reinforcement structure in the through-hole, it can increase the strength of the cap plate, thereby reducing deformation of the cap plate when the pressure inside the secondary battery increases, especially deformation of the cap plate at the through-hole, and in turn ensuring the connecting strength between the vent piece and the cap plate, improving the stability and the consistency of vent function of the cap assembly, and promoting the safety performance of the secondary battery.

### BRIEF DESCRIPTION OF THE FIGURES

FIG. 1 is a top view of a secondary battery according to the present disclosure in which a vent piece is not shown.

FIG. 2 is a cross sectional view taken along a line A-A of FIG. 1.

FIG. 3 is an enlarged view of a part of FIG. 2 within in a dotted line fame.

FIG. 4 is a schematic view of a cap assembly according to the present disclosure.

FIG. 5 is another schematic view of the cap assembly according to the present disclosure in which the vent piece is not shown.

FIG. 6 is a top view of another embodiment of the cap assembly according to the present disclosure in which the vent piece is not shown.

Reference numerals in figures are represented as follows:
1 cap assembly
   11 cap plate
      111 through-hole
      112 groove
   12 reinforcement structure
      121 first reinforcement beam
      122 second reinforcement beam
      123 third reinforcement beam
      124 fourth reinforcement beam
   13 vent piece
   14 electrode terminal
2 case
3 electrode assembly
H penetrating hole
X length direction
Y width direction
Z height direction

### DETAILED DESCRIPTION

Hereinafter a cap plate and a secondary battery according to the present disclosure will be described in detail in combination with the figures.

Firstly, a cap assembly according to a first aspect of the present disclosure will be described.

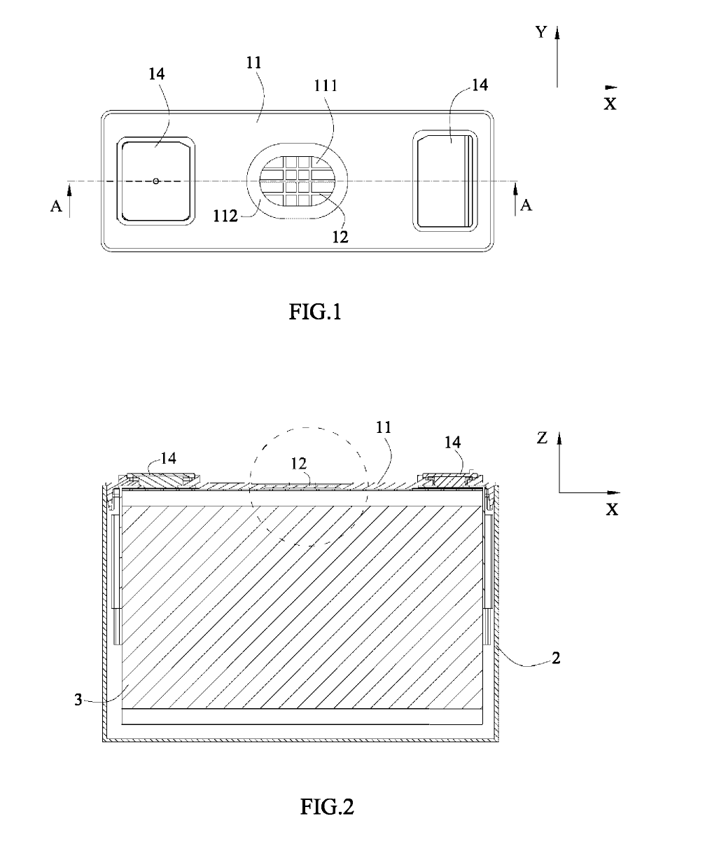

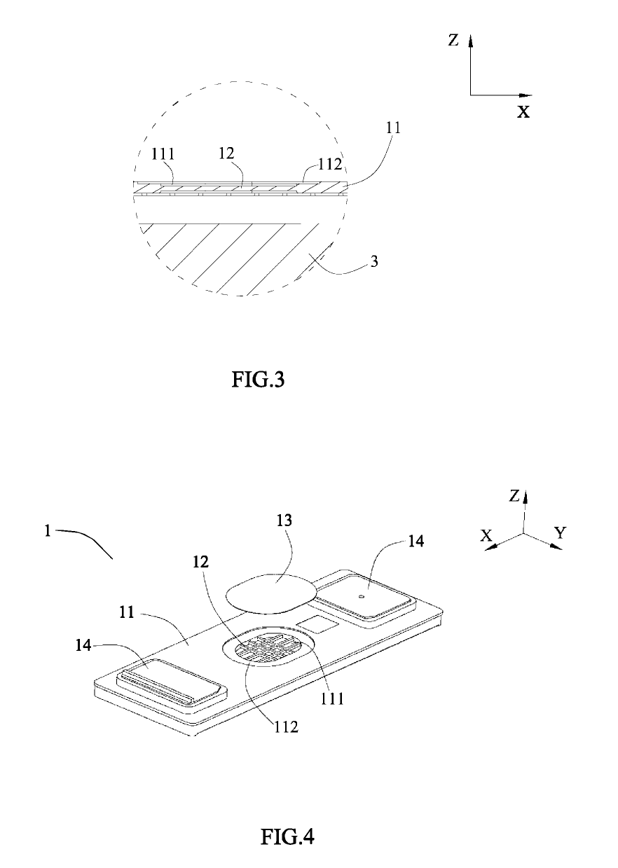

Referring to FIG. 1 to FIG. 6, a cap assembly 1 according to the present disclosure comprises a cap plate 11, a reinforcement structure 12 and a vent piece 13. The cap plate 11 is provided with a through-hole 111; the vent piece 13 is fixed with the cap plate 11 and covers the through-hole 111 from above. The reinforcement structure 12 is provided in the through-hole 111 and fixed with an inner wall of the through-hole 111, and the reinforcement structure 12 partially blocks the through-hole 111.

The cap assembly 1 according to the present disclosure is a component of a secondary battery, and used for sealing an electrode assembly 3 of the secondary battery inside a case 2. When the secondary battery works normally, a certain amount of gas will be generated in the secondary battery, thereby leading to deformation of the cap plate 1.

By providing the reinforcement structure 12 in the through-hole 111, it can increase the strength of the cap plate 11, especially the strength of a part of the cap plate 11 around the through-hole 111, thereby reducing the deformation of the cap plate 11 when the pressure inside the secondary battery increases, especially the deformation of the cap plate 11 at the through-hole 111, and in turn ensuring a connecting strength between the vent piece 13 and the cap plate 11, improving the stability and the consistency of vent function of the cap assembly 1, and promoting the safety performance of the secondary battery. At the same time, the reinforcement structure 12 only partially blocks the through-hole 111, so the reinforcement structure 12 will not limit the eruption of the gas inside the secondary battery.

The cap plate 11 and the reinforcement structure 12 are integrally formed and made from plastic. Compared to the conventional cap plate made of aluminum alloy, the cap plate 11 made from plastic has a smaller weight, which can promote the energy density of the secondary battery; at the same time, the cap plate 11 and the reinforcement structure 12 may be formed by injection molding, and the cost is low. Certainly, the cap plate 11 made from plastic is more prone to be deformed, so it is more necessary to promote the strength by providing the reinforcement structure 12, thereby reducing deformation of the cap plate 11 when the pressure inside the secondary battery increases. Preferably, the plastic is polypropylene.

The vent piece 13 is a thin sheet with a uniform thickness, and the vent piece 13 is made from plastic.

Referring to FIG. 4, a groove 112 recessed downwardly is provided on an upper surface of the cap plate 11, the vent piece 13 is fixed with a bottom wall of the groove 112 by welding. An upper surface of the vent piece 13 is lower than the upper surface of the cap plate 11, that is a thickness of the vent piece 13 is less than a depth of the groove 112. The through-hole 111 extends downwardly from a bottom wall of the groove 112. When assembling the vent piece 13, the groove 112 may function for positioning. The depth of the groove 112 may be 0.3 mm-1 mm.

Referring to FIG. 2 and FIG. 4, in a height direction Z, an upper surface of the reinforcement structure 12 is lower than the bottom wall of the groove 112, thereby making the vent piece 13 not contact the reinforcement structure 12, and avoiding the vent piece 13 protruding partially.

Referring to FIG. 2, the cap assembly 1 further comprises an electrode terminal 14, the electrode terminal 14 is used for being electrically connected with the electrode assembly 3 of the secondary battery.

The through-hole 111 is an electrolyte injection hole used for injecting an electrolyte. In the process of manufacturing the secondary battery, it can directly inject the electrolyte into the secondary battery via the through-hole 111. Certainly, the process of injecting the electrolyte is before the process of assembling the vent piece 13.

In the conventional secondary battery, the cap plate is generally provided with an electrolyte injection hole and a vent hole which are independent with each other, and the vent piece is used for sealing the vent hole. However, the electrolyte injection hole and the vent hole independent with each other occupy a large space in the cap plate, thereby limiting a dimension of the electrode terminal provided on the cap plate. In addition, after injecting the electrolyte, it further needs to seal the electrolyte injection hole by other component, which leads to the forming process of the cap plate being complex and the cost being high. The cap assembly 1 of the present disclosure can directly inject the electrolyte via the through-hole 111 used for vent function, and integrate the conventional electrolyte injection hole and the conventional vent hole together, thereby simplifying the forming process and reducing cost.

When injecting the electrolyte, an external electrolyte injection apparatus needs to downwardly press the cap plate 11 from above. Because the reinforcement structure 12 can increase the strength of the cap plate 11 at the through-hole 111, so it can reduce deformation of the cap plate 11 when injecting the electrolyte, avoid the cap plate 11 being depressed toward the inside of the case 2, and prevent the cap plate 11 crushing the electrode assembly 3.

Referring to FIG. 5, in order to prevent the reinforcement structure 12 blocking the electrolyte, the reinforcement structure 12 may be provided with a penetrating hole H in the middle, the electrolyte can pass through the penetrating hole H.

In the process of injecting the electrolyte, if there is no reinforcement structure 12 in the through-hole 111, when the electrolyte injection apparatus downwardly presses the cap plate 11, the bottom wall of the groove 112 will be prone to be depressed and deformed plastically, especially a part of the bottom wall contacting the electrolyte injection apparatus, and in turn affect the flatness of the bottom wall of the groove 112. When assembling the vent piece 13, due to poor flatness of the bottom wall of the groove 112, in the process of welding, it will lead to the contact between the vent piece 13 and the bottom wall of the groove 112 being poor, reduce the connecting strength and affect sealing performance.

In an embodiment, referring to FIG. 5, the reinforcement structure 12 comprises a first reinforcement beam 121, two ends of the first reinforcement beam 121 are fixed with the inner wall of the through-hole 111. Preferably, the first reinforcement beam 121 extends in a length direction X. When the pressure inside the secondary battery increases, the cap plate 11 is more prone to be deformed in the length direction X, and the first reinforcement beam 12 extending in the length direction X can reduce deformation. Furthermore, the first reinforcement beam 121 may be provided as plurality in number and the plurality of the first reinforcement beams 121 are arranged in parallel, a distance between two adjacent first reinforcement beams 121 may be 3 mm-5 mm. A cross section of the first reinforcement beam 121 is a rectangle.

Referring to FIG. 5, in order to further promote the strength of the cap plate 11, the reinforcement structure 12 further comprises a second reinforcement beam 122 crossing with the first reinforcement beam 121, two ends of the second reinforcement beam 122 are fixed with the inner wall of the through-hole 111. Preferably, the second reinforcement beam 122 extends in a width direction Y. Further, the second reinforcement beam 122 is provided as plurality in number and the plurality of the second reinforcement beams 122 are arranged in parallel, a distance between two adjacent second reinforcement beams 122 may be 3 mm-5 mm. The first reinforcement beams 121 and the second reinforcement beams 122 cross with each other to form the penetrating hole H. A section of the second reinforcement beam 12 is a rectangle.

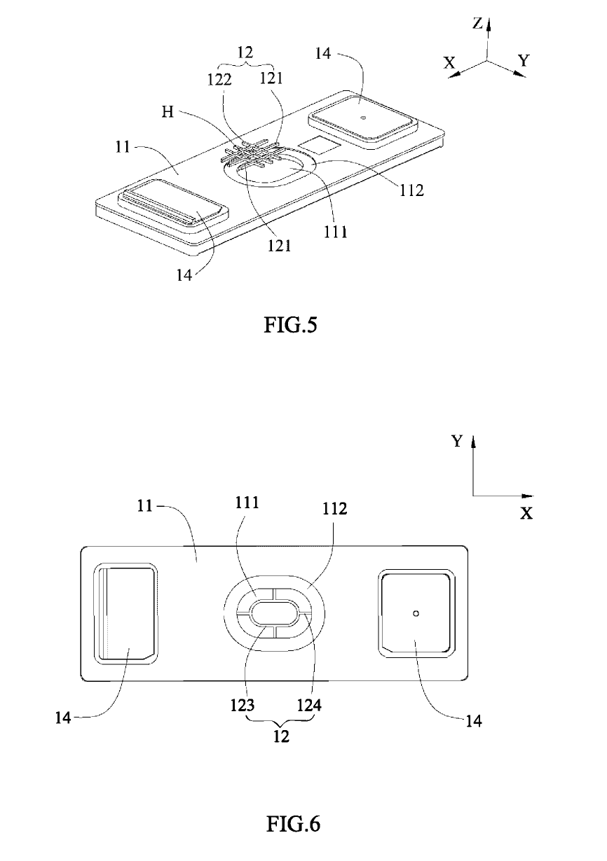

In another embodiment, referring to FIG. 6, the reinforcement structure 12 comprises a third reinforcement beam 123 and a fourth reinforcement beam 124, the third reinforcement beam 123 is annulus in shape, the fourth reinforcement beam 124 is provided around the third reinforcement beam 123 and connects the third reinforcement beam 123 and the inner wall of the through-hole 111. The penetrating hole H is encircled by the third reinforcement beam 123.

Secondly, a secondary battery according to a second aspect of the present disclosure will be described.

Referring to FIG. 1 to FIG. 6, a secondary battery according to the present disclosure comprises a case 2, an electrode assembly 3 and a cap assembly 1 according to the first aspect of the present disclosure. The case 2 has an opening in a top, the electrode assembly 3 is received in the case 2, and the cap assembly 1 is fixed with the case 2 in the top.

The electrode assembly 3 comprises a positive electrode plate, a negative electrode plate and a separator, the separator separates the positive electrode plate and the negative electrode plate. The electrode terminal 14 is provided as two in number, and the two electrode terminals 14 are respectively electrically connected with the positive electrode plate and the negative electrode plate.

When the secondary battery works normally, a certain amount of gas will be generated inside the secondary battery, thereby leading to a pressure inside the secondary battery increasing. By providing the reinforcement structure 12 in the through-hole 111, it can increase the strength of the cap plate 11, especially the strength of a part of the cap plate 11 around the through-hole 111, thereby reducing deformation of the cap plate 11 when the pressure inside the secondary battery increases, especially deformation of the cap plate 11 at the through-hole 111, and in turn ensuring the connecting strength between the vent piece 13 and the cap plate 11, improving the stability and the consistency of vent function of the cap assembly 1, and promoting the safety performance of the secondary battery.

In addition, the cap assembly 1 of the present disclosure can directly inject the electrolyte via the through-hole 111 used for vent function, and integrate the conventional electrolyte injection hole and the conventional vent hole together, thereby simplifying the forming process and reducing the cost. At the same time, the reinforcement structure 12 can increase the strength of the cap plate 11 at the through-hole 111, so it can reduce deformation of the cap plate 11 when injecting the electrolyte, avoid the cap plate 11 being depressed toward the inside of the case 2, prevent the cap plate 11 crushing the electrode assembly 3, and promote the safety performance of the secondary battery.

The case 2 is preferably made from plastic. The case 2 may be welded with the cap plate 11. Both of the case 2 made from plastic and the cap plate 11 made from plastic have a small weight, which can promote the energy density of the secondary battery, simplify the forming process and reduce the cost effectively.

1.-11. (canceled)

12. A cap assembly, comprising:
a cap plate provided with a through-hole;
a vent piece fixed with the cap plate and covering the through-hole from above; and
a reinforcement structure provided in the through-hole, fixed with an inner wall of the through-hole and partially blocking the through-hole.

13. The cap assembly according to claim 12, wherein the through-hole is an electrolyte injection hole used for injecting an electrolyte.

14. The cap assembly according to claim 12, wherein the reinforcement structure comprises a first reinforcement beam, two ends of the first reinforcement beam are fixed with the inner wall of the through-hole.

15. The cap assembly according to claim 14, wherein the first reinforcement beam extends in a length direction.

16. The cap assembly according to claim 14, wherein the reinforcement structure further comprises a second reinforcement beam crossing with the first reinforcement beam, two ends of the second reinforcement beam are fixed with the inner wall of the through-hole.

17. The cap assembly according to claim 12, wherein
the reinforcement structure comprises a third reinforcement beam and a fourth reinforcement beam, the third reinforcement beam is annulus in shape, the fourth reinforcement beam is provided around the third reinforcement beam and connects the third reinforcement beam and the inner wall of the through-hole.

18. The cap assembly according to claim 12, wherein the cap plate and the reinforcement structure are integrally formed and made from plastic.

19. The cap assembly according to claim 12, wherein the vent piece is a thin sheet with a uniform thickness, and the vent piece is made from plastic.

20. The cap assembly according to claim 19, wherein
a groove recessed downwardly is provided on an upper surface of the cap plate;
the vent piece is fixed with a bottom wall of the groove by welding, and an upper surface of the vent piece is lower than the upper surface of the cap plate;
the through-hole extends downwardly from a bottom wall of the groove.

21. The cap assembly according to claim 20, wherein
in a height direction, an upper surface of the reinforcement structure is lower than the bottom wall of the groove.

22. A secondary battery, comprising:
a case having an opening in a top thereof;
an electrode assembly received in the case; and
a cap assembly fixed with the top of the case;
the cap assembly comprising:
a cap plate provided with a through-hole;
a vent piece fixed with the cap plate and covering the through-hole from above; and
a reinforcement structure provided in the through-hole, fixed with an inner wall of the through-hole and partially blocking the through-hole.

23. The secondary battery according to claim 22, wherein the through-hole is an electrolyte injection hole used for injecting an electrolyte.

24. The secondary battery according to claim 22, wherein the reinforcement structure comprises a first reinforcement beam, two ends of the first reinforcement beam are fixed with the inner wall of the through-hole.

25. The secondary battery according to claim 24, wherein the first reinforcement beam extends in a length direction.

26. The secondary battery according to claim 24, wherein the reinforcement structure further comprises a second reinforcement beam crossing with the first reinforcement beam, two ends of the second reinforcement beam are fixed with the inner wall of the through-hole.

27. The secondary battery according to claim 22, wherein
the reinforcement structure comprises a third reinforcement beam and a fourth reinforcement beam, the third reinforcement beam is annulus in shape, the fourth reinforcement beam is provided around the third reinforcement beam and connects the third reinforcement beam and the inner wall of the through-hole.

28. The secondary battery according to claim 22, wherein the cap plate and the reinforcement structure are integrally formed and made from plastic.

29. The secondary battery according to claim 22, wherein the vent piece is a thin sheet with a uniform thickness, and the vent piece is made from plastic.

30. The secondary battery according to claim 29, wherein
a groove recessed downwardly is provided on an upper surface of the cap plate;
the vent piece is fixed with a bottom wall of the groove by welding, and an upper surface of the vent piece is lower than the upper surface of the cap plate;
the through-hole extends downwardly from a bottom wall of the groove.

31. The secondary battery according to claim 30, wherein
in a height direction, an upper surface of the reinforcement structure is lower than the bottom wall of the groove.
